(19) United States
(12) Patent Application Publication
(10) Pub. No.: US 2026/0180732 A1
(43) Pub. Date: Jun. 25, 2026

(54) CHANNEL BANDWIDTH ADAPTATION METHOD AND DEVICE THEREOF FOR IMPLEMENTING LOW-LATENCY CHANNEL MANAGEMENT

(71) Applicant: MEDIATEK INC., Hsinchu City (TW)

(72) Inventors: Wan-Feng Chiang, Hsinchu City (TW); Yu-Chen Kuo, Hsinchu City (TW)

(73) Assignee: MEDIATEK INC., Hsinchu City (TW)

(21) Appl. No.: 19/357,072

(22) Filed: Oct. 13, 2025

Related U.S. Application Data
(60) Provisional application No. 63/883,730, filed on Sep. 18, 2025.
(60) Provisional application No. 63/707,276, filed on Oct. 15, 2024.

(51) Int. Cl. H04L 5/00; H04W 4/40; H04W 84/12

(52) U.S. Cl. CPC H04L 5/0037; H04W 4/40; H04W 84/12

(57) ABSTRACT

A channel bandwidth adaptation method performed by a WLAN circuit for use in a WLAN device includes monitoring N sub-channels within a selected channel to determine N channel conditions, selecting M sub-channels from the N sub-channels based on at least the N channel conditions to adapt an operating channel, and notifying a peer WLAN device of an adapted operating channel including the M sub-channels.

### CROSS REFERENCE TO RELATED APPLICATIONS

This application claims the benefit of U.S. Provisional Application No. 63/707,276, filed on October 15th, 2024. Further, this application claims the benefit of U.S. Provisional Application No. 63/883,730, filed on September 18th, 2025. The contents of these applications are incorporated herein by reference.

### BACKGROUND

WLAN (Wireless local area network) systems used in vehicles, including Apple CarPlay, typically operate in the 5.8 GHz Wi-Fi band (5725–5895 MHz). These WLAN systems are vulnerable to interference from both non-Wi-Fi and Wi-Fi sources. Non-Wi-Fi interference may come from Intelligent Transportation Systems (ITS) operating in the 5855–5925 MHz range, and Transport and Traffic Telematics (TTT) systems in the 5795–5815 MHz range. Wi-Fi-based interference may originate from devices such as surveillance cameras, environmental monitors, and public hotspots. Such interference can lead to signal distortion and reduced signal-to-noise ratio (SNR), impacting communication quality.

### SUMMARY

An embodiment of the present invention provides a channel bandwidth adaptation method performed by a WLAN circuit for use in a WLAN device. The method includes monitoring N sub-channels within a selected channel to determine N channel conditions, selecting M sub-channels from the N sub-channels based on at least the N channel conditions to adapt an operating channel, notifying a peer WLAN device of an adapted operating channel including the M sub-channels. N is a quantity of sub-channels in the selected channel, and N is an integer greater than 1. M is a positive integer less than or equal to N.

Another embodiment of the present invention provides a channel bandwidth adaptation method performed by a WLAN circuit for use in a WLAN device. The method includes operating in a selected channel including N sub-channels, selecting M sub-channels from the N sub-channels based on at least presence of a known interference source to adapt an operating channel, and notifying a peer WLAN device of an adapted operating channel including the M sub-channels. N is a quantity of sub-channels in the selected channel, and N is an integer greater than 1. M is a positive integer less than or equal to N.

Another embodiment of the present invention provides a WLAN device. The device includes a WLAN circuit, a processing unit, and a memory. The WLAN circuit is configured to monitor N sub-channels within a selected channel to determine N channel conditions. The memory is coupled to the processing unit and configured to store instructions. The instructions, when executed by the processing unit, causes the processing unit to select M sub-channels from the N sub-channels based on at least the N channel conditions to adapt an operating channel. The WLAN circuit is further configured to notify a peer WLAN device of an adapted operating channel including the M sub-channels. N is a quantity of sub-channels in the selected channel, and N is an integer greater than 1. M is a positive integer less than or equal to N.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a scenario according to an embodiment of the present invention.

FIG. 2 is a schematic diagram of a spectrum for a WLAN device according to an embodiment of the present invention.

FIG. 3 is a block diagram of a WLAN device according to an embodiment of the present invention.

FIG. 4 is a flow chart of a channel bandwidth adaptation method performed a WLAN device according to an embodiment of the present invention.

FIG. 5 is a bar chart of the channel conditions of the sub channels according to an embodiment of the present invention.

FIG. 6A is a flow chart of a channel bandwidth adaptation method performed by a WLAN device according to another embodiment of the present invention.

FIG. 6B is a schematic diagram of an example using the channel bandwidth adaptation method according to an embodiment of the present invention.

FIG. 7 is a flow chart of a channel bandwidth adaptation method performed by a WLAN device according to another embodiment of the present invention.

FIG. 8 is a flow chart of a channel bandwidth adaptation method performed by a WLAN device according to another embodiment of the present invention.

FIG. 9 is a flow chart of a channel bandwidth adaptation method performed by a WLAN device according to another embodiment of the present invention.

FIG. 10 is a flow chart of a channel bandwidth adaptation method performed by a WLAN device according to another embodiment of the present invention.

FIG. 11 is a schematic diagram of a scenario according to an embodiment of the present invention.

### DETAILED DESCRIPTION

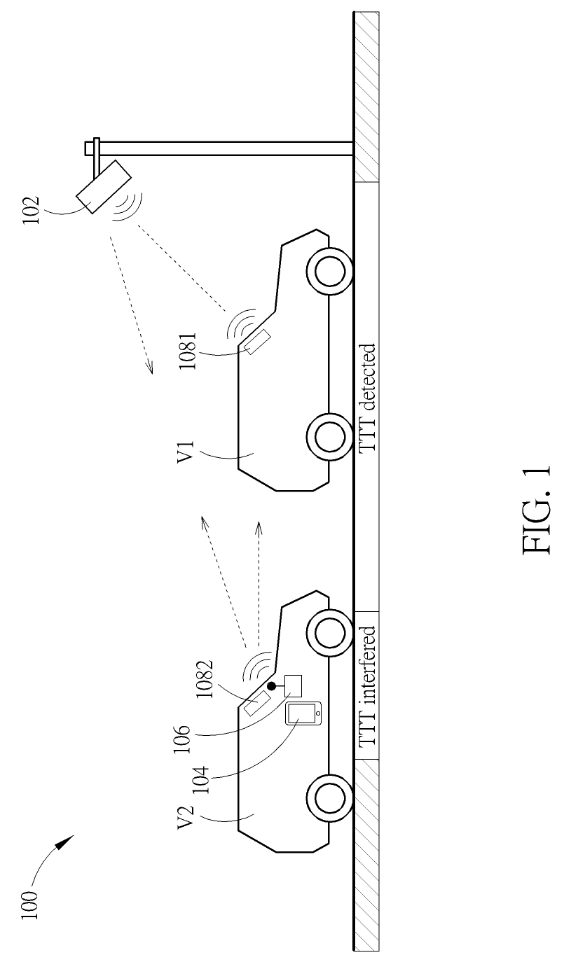

FIG. 1 is a schematic diagram of a scenario 100 according to an embodiment of the present invention. In the scenario 100, vehicles V1 and V2 travel along a highway and approach a toll transaction terminal (TTT) road-side unit (RSU) 102. The vehicle V2 may be equipped with a WLAN device 106, a peer WLAN device 104, and a TTT cabin-based unit (CBU) 1082. The vehicle V1 may be equipped with a TTT CBU 1081.

The WLAN (wireless local area network) device 106 may be an in-car infotainment system such as Apple CarPlay system. The WLAN device 106 may be configured as an SAP (soft AP) to operate in the 2.4 GHz and 5 GHz bands, distributing connectivity to linked devices obtained via a cellular backhaul. The tolling system often utilizes DSRC (dedicated short-range communications), or V2X (vehicle-to-everything) technologies in spectrum bands adjacent to or overlapping with Wi-Fi frequencies, particularly around 5.8–5.9 GHz.

The peer WLAN device 104 may be a smartphone linked to the WLAN device 106.

As the vehicles V1 and V2 approach the TTT RSU 102, the TTT RSU 102 initiates communication using DSRC or V2X signals. The vehicle V1, equipped with the TTT CBU 1081, enters the detection zone and actively exchanges data with the TTT RSU 102, while the vehicle V2, though outside the detection zone, may still experience interference due to proximity. This interference can degrade WLAN performance between the WLAN device 106 and linked WLAN device 104.

In the scenario 100, maintaining communication quality after switching channels requires additional radio equipment or forces a WLAN device to spend extra time scanning other channels. This increases both cost and latency.

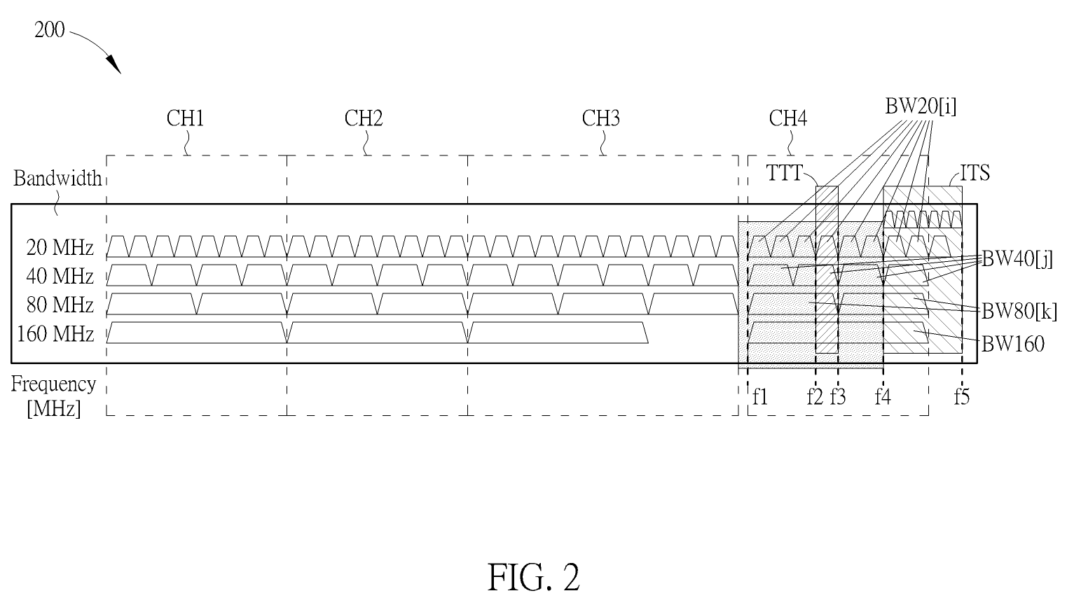

FIG. 2 is a schematic diagram of a spectrum 200 for a WLAN device 106 according to an embodiment of the present invention. Suppose the WLAN device 106 can be operated on a channel CH4 BW160 which has a 160MHz bandwidth, the 160MHz bandwidth can be divided into eight 20MHz sub-channels BW20[0-7]. When a 20MHz sub-channel BW20[3] experiences significant interference from the TTT RSU 102 while other sub-channels BW20[0-2, 4-7] only experience little interference, instead of switching to another channel such as CH1-CH3 to avoid the channel CH4 completely, some of the sub-channels BW20[0-2, 4-7] which experience little interference may be continuously used to operate the WLAN device 106. In this case, sub-channels BW20[4-7] would be aggregated to form an operating channel BW80[1] of 80MHz because sub-channel BW20[3] prevents sub-channels BW20[0-2] and sub-channels BW20[4-7] to be bonded together. Though sub-channels BW20[0-1] can be bonded to form an operating channel BW40[0], sub-channels BW20[4-5] can be bonded to form an operating channel BW40[2], sub-channels BW20[6-7] can be bonded to form an operating channel BW40[3] of 40MHz, the 40MHz operating channels BW40[0, 2, 3] are each narrower than the 80MHz operating channel BW80[1], thus the operating channel BW80[1] is employed for operating the WLAN device 106. The sub-channels BW20[0-2, 4-7] which are not bonded would not be employed as an operating channel because their bandwidths are also narrower than the 80MHz operating channel BW80[1].

While TTT interference is used as an example in this embodiment, other sources such as ITS (intelligent transportation system) signals or overlapping Wi-Fi communications may also interfere with the channel CH4. Those skilled in the art can apply the similar principles to dynamically adapt the operating channel’s bandwidth in response to various types of interference.

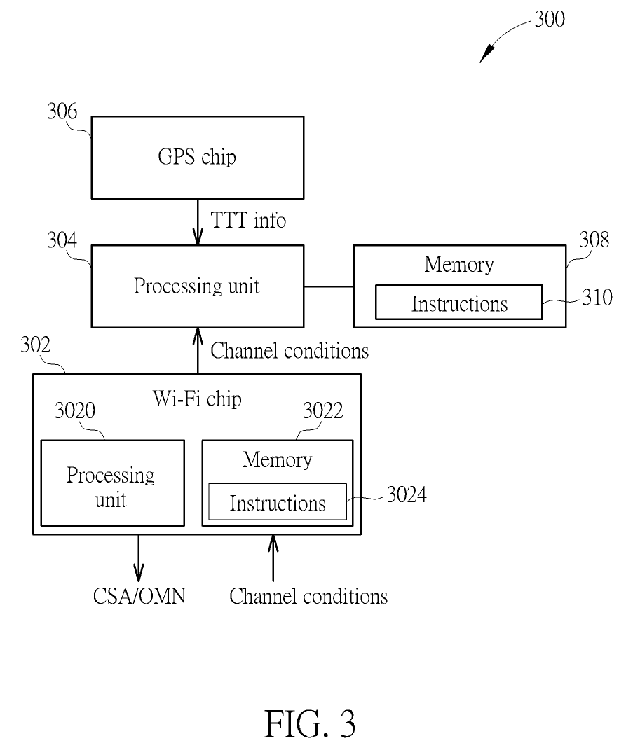

FIG. 3 is a block diagram of a WLAN device 300 according to an embodiment of the present invention. The WLAN device 300 may be the WLAN device 106 in FIG. 1, and may include a Wi-Fi chip 302, a processing unit 304, a GPS (Global Positioning System) chip 306, and a memory 308. The Wi-Fi chip 302 may include a processing unit 3020 and a memory 3022. The processing units 304 and 3020 may be a central processing unit, a graphics processing unit, a microcontroller unit, a microprocessor, or other processing units.

The Wi-Fi chip 302 may serve as a WLAN circuit to monitor N sub-channels within a selected channel to determine their channel conditions, where N is an integer greater than 1. In an embodiment, N is the number of all sub-channels in the selected channel. Specifically, the Wi-Fi chip 302 may monitor channel conditions across the selected channel by subdividing the bandwidth of the selected channel into discrete 20 MHz sub-channels BW20[0] to BW20[7] and continuously assessing each sub-channel BW20[i] independently for interference and signal quality. The Wi-Fi chip 302 may perform energy detection and spectrum analysis on each sub-channel BW20[i] within the configured bandwidth (e.g., 160 MHz) of the selected channel to identify sub-channels experiencing narrowband interference, co-channel occupation, or degraded signal-to-noise ratio below predetermined thresholds.

The processing unit 304 and the memory 308 are located outside the Wi-Fi chip 302, with the processing unit 304 being coupled to the Wi-Fi chip 302 and the GPS chip 306, and the memory 308 being coupled to the processing unit 304. The memory 308 can be a non-volatile memory having instructions 310 stored therein. Further, the processing unit 3020 and the memory 3022 are located inside the Wi-Fi chip 302, with the memory 3022 being coupled to the processing unit 3020. The memory 3022 can be a non-volatile memory having instructions 3024 stored therein. The instructions 310 stored in the memory 308 may be a driver program, while the instructions 3024 stored in the memory 3022 may be a firmware program.

In one embodiment, the instructions 310, when executed by the processing unit 304, causes the processing unit 304 to select M sub-channels which experience little channel interferences from the N sub-channels based on at least the N channel conditions. In another embodiment, the instructions 3024, when executed by the processing unit 3020, causes the processing unit 3020 to select M sub-channels which experience little channel interferences from the N sub-channels based on at least the N channel conditions. In another embodiment, the processing units 304 and 3020 may execute the instructions 310 and 3024 respectively to jointly select M sub-channels from N based on channel conditions and adapt the operating channel. The M sub-channels form an operating channel, and the bandwidth of the operating channel is determined by the M sub-channels. M is a positive integer less than or equal to N. The WLAN device 300 may transmit and receive data across the M sub-channels within the operating channel. In some embodiments, the operating channel may include all sub-channels of the selected channel when all N sub-channel experience little channel interferences. In other embodiments, the operating channel may include only a portion of N sub-channels in the selected channel when only the portion experience little channel interferences. Subsequently, the Wi-Fi chip 302 is further used to notify a peer WLAN device of an adapted operating channel including the M sub-channels.

In an embodiment, the GPS chip 306 sends TTT information or ITS information to the processing unit 304, and the Wi-Fi chip 302 sends the channel conditions of the N sub-channels of the selected channel to the processing unit 304. With the channel conditions of the N sub-channels and the TTT/ITS information, the processing unit 304 can adjust the operating channel in the spectrum by using the channel switch announcement (CSA) and the operation mode notification (OMN) to avoid the Wi-Fi chip 302 operating in the same band of the TTT RSU 102, the ITS device, or other interference sources.

In an embodiment, the instructions 310 on the processing unit 304 and/or the instructions 3024 on the processing unit 3020 may remove, from the N sub-channels, any sub-channel having channel interference, thereby retaining sub-channels which experience little channel interference. Then based on bandwidth requirement of the operating channel, the instructions 310 on the processing unit 304 and/or the instructions 3024 on the processing unit 3020 may select the M sub-channels from the retained sub-channels to form the operating channel. For instance, if the bandwidth requirement of the operating channel is 40MHz while each sub-channel has a bandwidth of 20MHz, then only two of the retained sub-channels can be selected to form the operating channel.

In an embodiment, the instructions 310 on the processing unit 304 and/or the instructions 3024 on the processing unit 3020 may identify a known interference source operating on one of the N sub-channels. The known interference source may be a TTT device or an ITS device. Once the known interference source is identified, the sub-channel is removed from the N sub-channels, and the operating channel is selected from the remaining sub-channels.

In an embodiment, the instructions 310 on the processing unit 304 and/or the instructions 3024 on the processing unit 3020 may receive external channel conditions from the peer WLAN device. Once the external channel conditions are received, sub-channels with channel interference are removed from the N sub-channels, and the operating channel is selected from the remaining sub-channels.

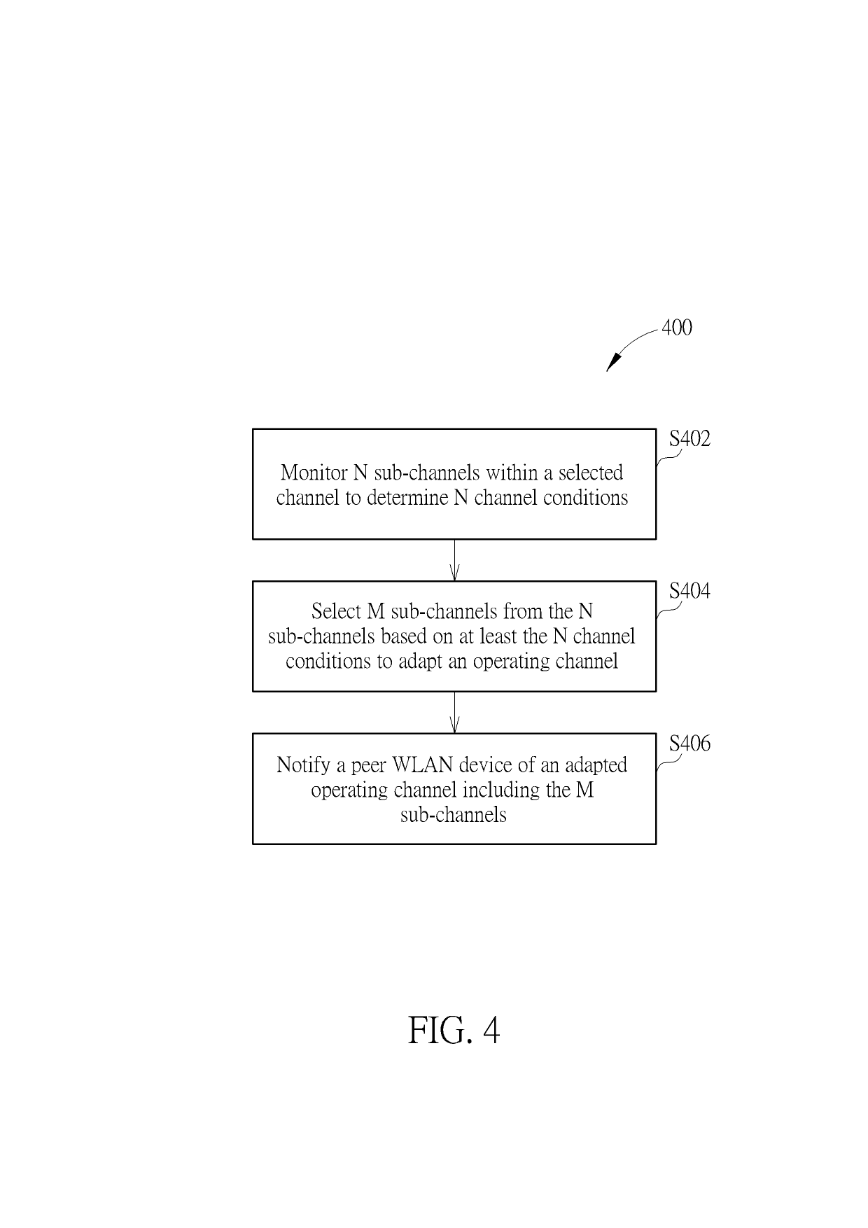

FIG. 4 is a flow chart of a channel bandwidth adaptation method 400 performed by the WLAN device 106 according to an embodiment of the present invention. The method 400 includes the following steps:

Step S402: Monitor N sub-channels within a selected channel to determine N channel conditions;

Step S404: Select M sub-channels from the N sub-channels based on at least the N channel conditions to adapt an operating channel; and

Step S406: Notify a peer WLAN device of an adapted operating channel including the M sub-channels.

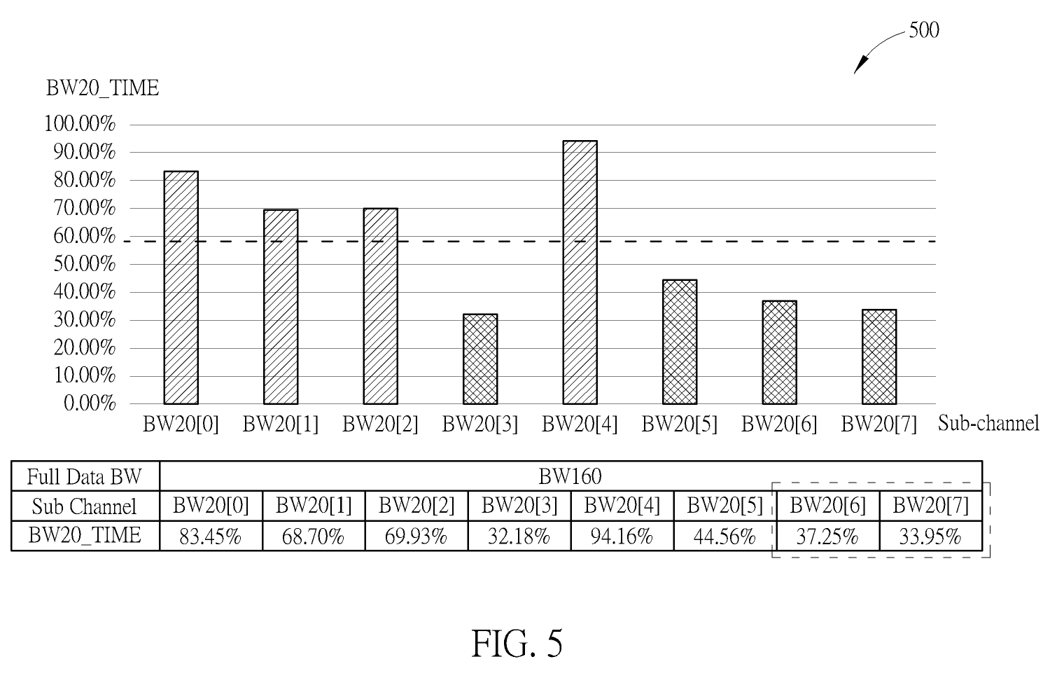

FIG. 5 is a bar chart of the channel conditions 500 of the sub-channels BW20[0-7] according to an embodiment of the present invention. In the bar chart, the horizontal axis refers to the 8 sub-channels BW20[0-7] in FIG. 2, the vertical axis refers to the interference percentage BW20_TIME of each of the sub-channel BW20[0-7]. The interference percentage BW20_TIME in FIG. 5 is used to represent channel condition. In an embodiment, the threshold of interference percentage BW20_TIME is defined as 60%. As shown in FIG. 5, sub-channels BW20[0], BW20[1], BW20[2], BW20[4] exceed the threshold, and sub-channels BW20[3], BW20[5], BW20[6], BW20[7] are below the threshold. Therefore, sub-channels BW20[0], BW20[1], BW20[2], BW20[4] should be removed from the 8 sub-channels, and sub-channels BW20[3], BW20[5], BW20[6], BW20[7] are retained. If the bandwidth requirement of the operating channel is 40MHz, only sub-channels BW20[6] and BW20[7] can be aggregated to form the operating channel because as shown in FIG. 2, only sub-channels BW20[0] and BW20[1] can be aggregated together, only sub-channels BW20[2] and BW20[3] can be aggregated together, only sub-channels BW20[4] and BW20[5] can be aggregated together, and only sub-channels BW20[6] and BW20[7] can be aggregated together to form an operating channel of 40MHz . One of the sub-channels of the operating channel is selected as a primary channel for synchronization and management, the remaining sub-channels are secondary channels for data transmission. If the bandwidth requirement of the operating channel is 20MHz, then any of the sub-channels BW20[3], BW20[5], BW20[6], BW20[7] can be selected to be the operating channel, the selected sub-channel is assigned as the primary channel, and the operating channel would not have any secondary channel. The retained sub-channels BW20[3], BW20[5], BW20[6], BW20[7] are unable to form an operating channel of 80MHz because as shown in FIG. 2, only sub-channels BW20[0], BW20[1], BW20[2], BW20[3] can be aggregated together, and only sub-channels BW20[4], BW20[5], BW20[6], BW20[7] can be aggregated together to form an operating channel of 80MHz.

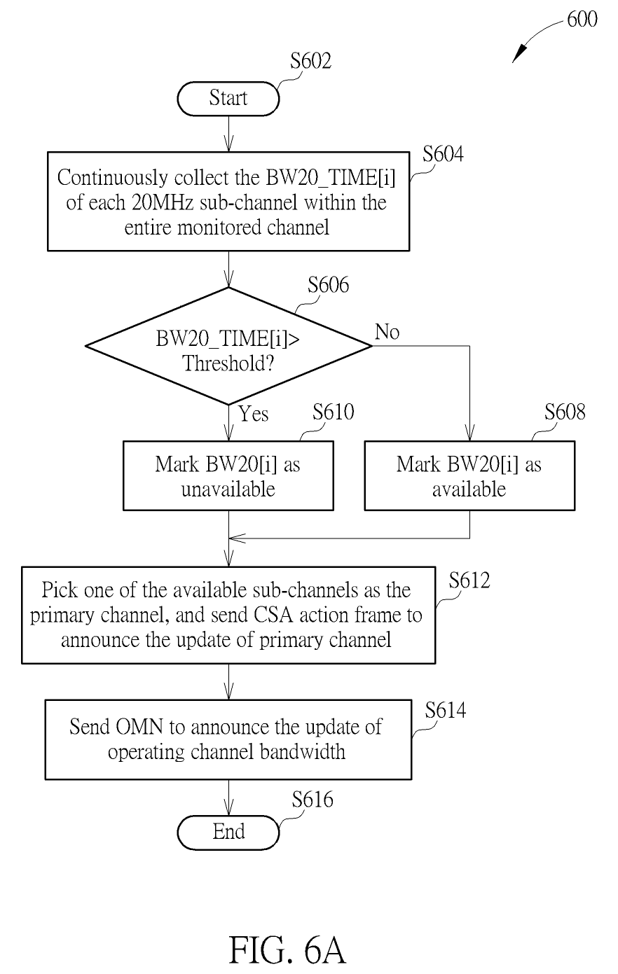

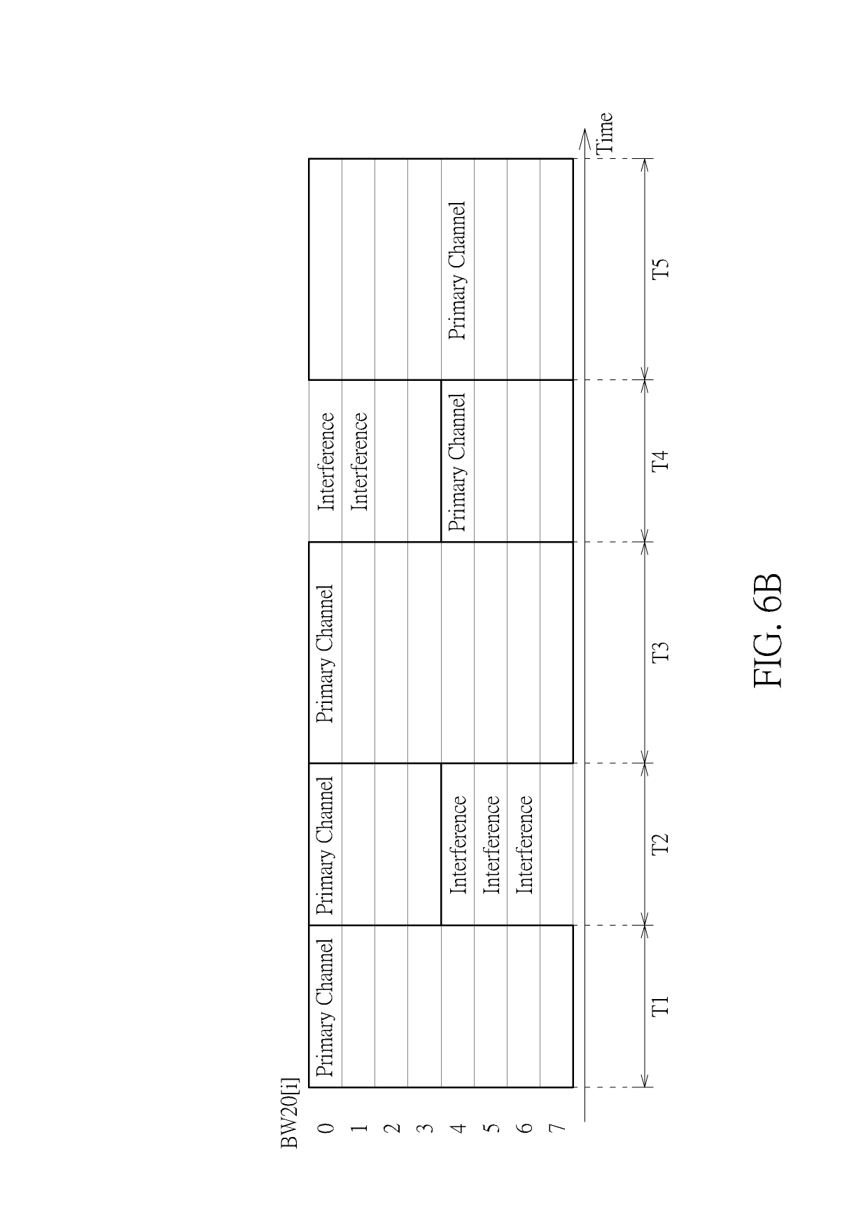

FIG. 6A is a flow chart of a channel bandwidth adaptation method 600 performed by the WLAN device 106 according to another embodiment of the present invention. The method 600 includes the following steps:

Step S602: Start;

Step S604: Continuously collect the BW20_TIME[i] of each 20MHz sub-channel within the entire monitored channel;

Step S606: Does BW20_TIME[i] exceed the threshold? If so, go to step S610; otherwise, go to step S608;

Step S608: Mark sub-channel BW20[i] as available; go to step S612;

Step S610: Mark sub-channel BW20[i] as unavailable;

Step S612: Pick one of the available sub-channels as the primary channel, and send CSA action frame to announce the update of primary channel;

Step S614: Send OMN to announce the update of operating channel bandwidth; and

Step S616: End.

FIG. 6B is a schematic diagram of an example using the channel bandwidth adaptation method 600 according to an embodiment of the present invention. The WLAN device 106 would continuously monitor the channel conditions of the sub-channels BW20[0-7]. In time interval T1, the 8 sub-channels BW20[0-7] have little interference, so BW20[0] is set as the primary channel, and all sub-channels BW20[0-7] are selected to form the operating channel. In time interval T2, the 3 sub-channels BW20[4-6] experience significant interference, so the primary channel BW20[0] remains unchanged, and sub-channels BW20[0-3] are selected to form the operating channel. As a result, the WLAN device 106 transmits an OMN to indicate the bandwidth of the operating channel is reduced from 160MHz to 80MHz. In time interval T3, the 8 sub-channels BW20[0-7] have little interference, so the primary channel BW20[0] remains unchanged, and all sub-channels BW20[0-7] are selected to form the operating channel. As a result, the WLAN device 106 transmits an OMN to indicate the bandwidth of the operating channel is increased from 80MHz to 160MHz. In time interval T4, the 2 sub-channels BW20[0-1] experience significant interference, so BW20[4] is set as the primary channel, and sub-channels BW20[4-7] are selected to form the operating channel. As a result, the WLAN device 106 transmits an OMN to indicate the bandwidth of the operating channel is reduced from 160MHz to 80MHz, and transmits a CSA to indicate the primary channel is changed from the sub-channel BW20[0] to sub-channel BW20[4]. In time interval T5, the sub-channels BW20[0-7] have little interference, so the primary channel BW20[4] remains unchanged, and all sub-channels BW20[0-7] are selected to form the operating channel. As a result, the WLAN device 106 transmits an OMN to indicate the bandwidth of the operating channel is increased from 80MHz to 160MHz.

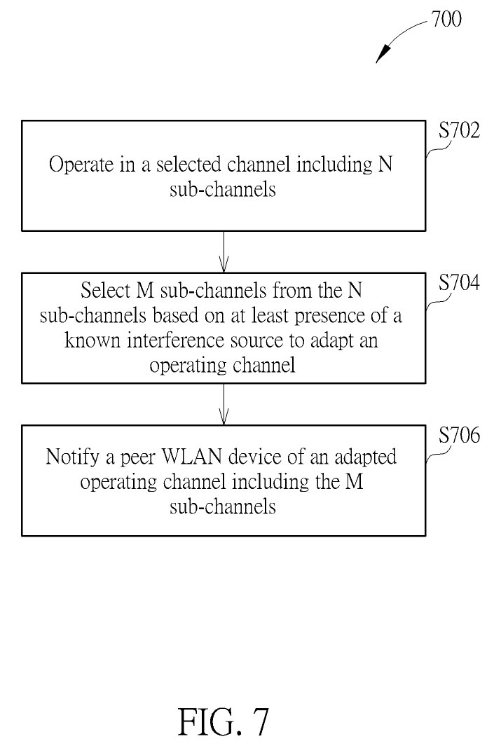

FIG. 7 is a flow chart of a channel bandwidth adaptation method 700 performed by the WLAN device 106 according to another embodiment of the present invention. The method 700 includes the following steps:

Step S702: Operate in a selected channel including N sub-channels;

Step S704: Select M sub-channels from the N sub-channels based on at least presence of a known interference source to adapt an operating channel; and

Step S706: Notify a peer WLAN device of an adapted operating channel including the M sub-channels.

The channel bandwidth adaptation method 700 is different from the channel bandwidth adaptation method 400 in that the channel bandwidth adaptation method 700 selects sub-channels of the operating channel based on the presence of known interference sources.

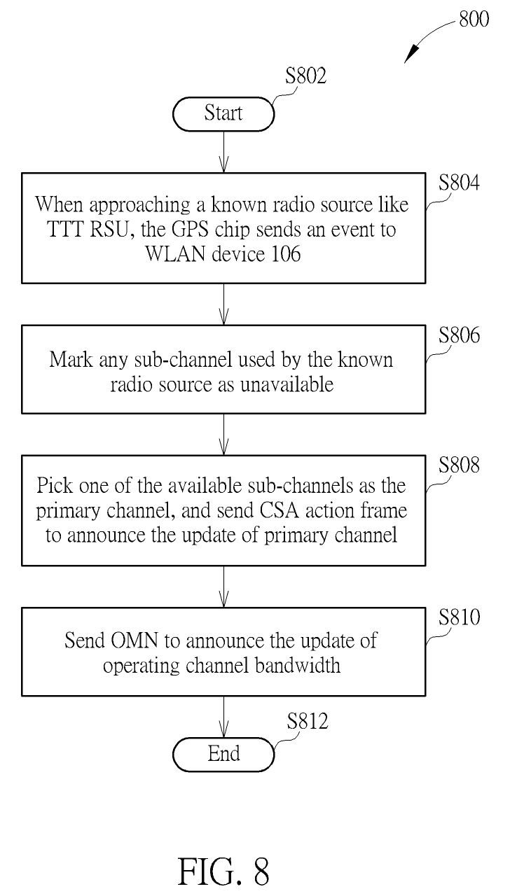

FIG. 8 is a flow chart of a channel bandwidth adaptation method 800 performed by the WLAN device 106 according to another embodiment of the present invention. The method 800 includes the following steps:

Step S802: Start;

Step S804: When approaching a known radio source like TTT RSU, the GPS chip sends an event to WLAN device 106;

Step S806: Mark any sub-channel used by the known radio source as unavailable;

Step S808: Pick one of the available sub-channels as the primary channel, and send CSA action frame to announce the update of primary channel;

Step S810: Send OMN to announce the update of operating channel bandwidth; and

Step S812: End.

The channel bandwidth adaptation method 800 is different from the channel bandwidth adaptation method 500 in that the channel bandwidth adaptation method 800 selects sub-channels of the operating channel based on the presence of known interference sources.

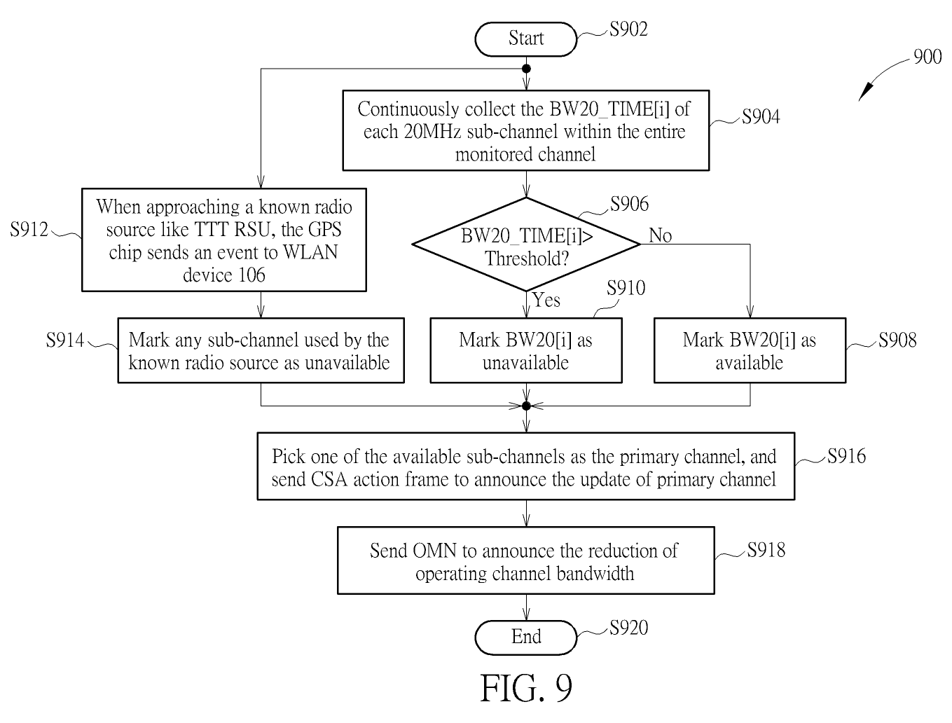

FIG. 9 is a flow chart of a channel bandwidth adaptation method 900 performed by the WLAN device 106 according to another embodiment of the present invention. The method 900 includes the following steps:

Step S902: Start;

Step S904: Continuously collect the BW20_TIME[i] of each 20MHz sub-channel within the entire monitored channel;

Step S906: Does BW20_TIME[i] exceed the threshold? If so, go to step S910; otherwise, go to step S908;

Step S908: Mark sub-channel BW20[i] as available; go to step S916;

Step S910: Mark sub-channel BW20[i] as unavailable; go to step S916;

Step S912: When approaching a known radio source like TTT RSU, the GPS chip sends an event to WLAN device 106;

Step S914: Mark any sub-channel used by the known radio source as unavailable;

Step S916: Pick one of the available sub-channels as the primary channel, and send CSA action frame to announce the update of primary channel;

Step S918: Send OMN to announce the reduction of operating channel bandwidth; and

Step S920: End.

The channel bandwidth adaptation method 900 is different from the channel bandwidth adaptation method 500 in that the channel bandwidth adaptation method 900 selects sub-channels of the operating channel based on both the channel conditions and the presence of known interference sources.

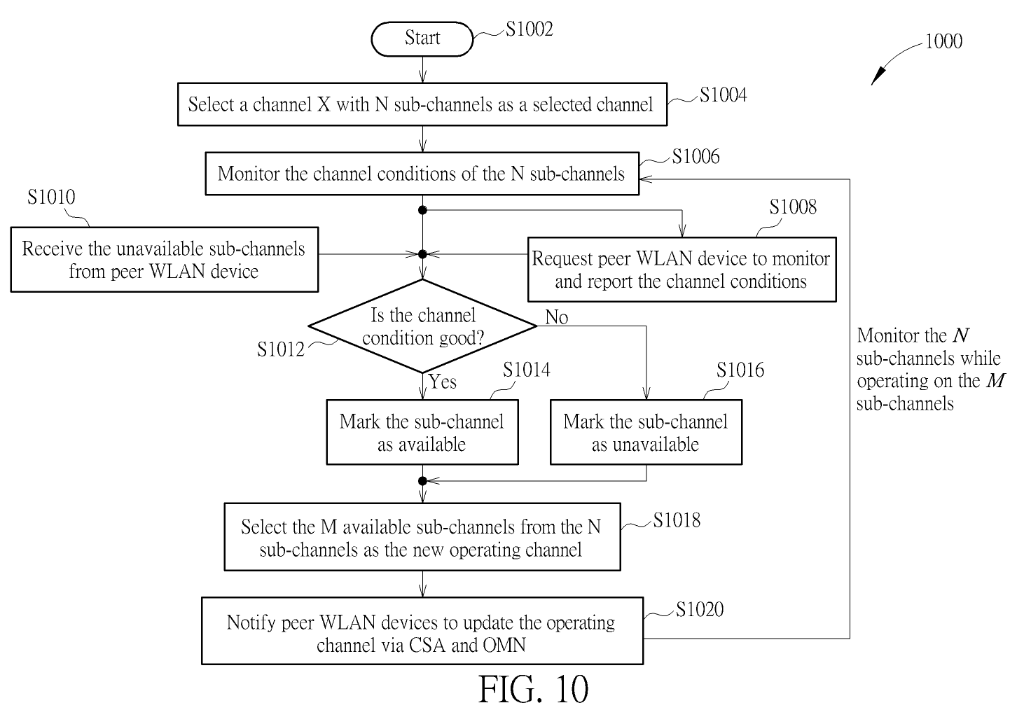

FIG. 10 is a flow chart of a channel bandwidth adaptation method 1000 performed by a WLAN device according to another embodiment of the present invention. The method 1000 includes the following steps:

Step S1002: Start;

Step S1004: Select a channel X with N sub-channels as a selected channel;

Step S1006: Monitor the channel conditions of the N sub-channels;

Step S1008: Request peer WLAN device to monitor and report the channel conditions; go to step S1012;

Step S1010: Receive the unavailable sub-channels from peer WLAN device;

Step S1012: Is the channel condition good? If so, go to step S1014; otherwise, go to step S1016;

Step S1014: Mark the sub-channel as available; go to step S1018;

Step S1016: Mark the sub-channel as unavailable;

Step S1018: Select the M available sub-channels from the N sub-channels as the new operating channel; and

Step S1020: Notify peer WLAN devices to update the operating channel via CSA and OMN, and go to step S1006.

The channel bandwidth adaptation method 1000 is different from the channel bandwidth adaptation method 500 in that the channel bandwidth adaptation method 1000 selects sub-channels of the operating channel based on the external channel conditions from the peer WLAN device. In some embodiments, the WLAN device may receive a preamble puncturing (PP) bitmap indicating the external channel conditions from the peer WLAN device.

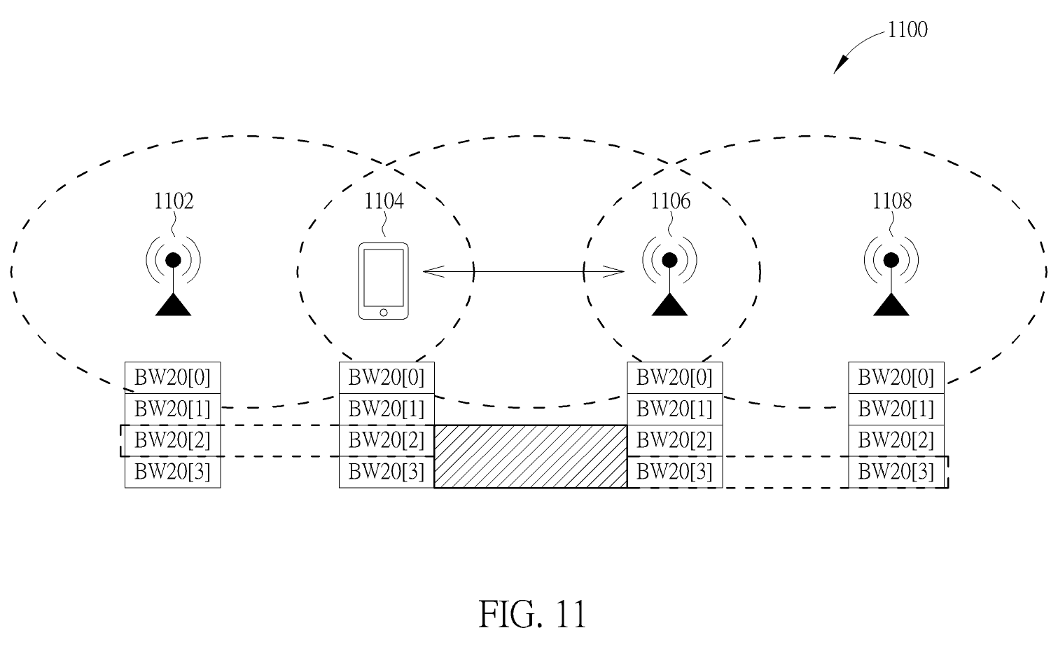

FIG. 11 is a schematic diagram of a scenario 1100 according to an embodiment of the present invention. In the scenario 1100, an wireless device (WD) 1102 operates on the sub-channel BW20[2], an access point (AP) 1106 operates on the BW80 channel including 4 sub-channels BW20[0-3], and an WD 1108 operates on the sub-channel BW20[3]. The Wi-Fi device 1104 is linked with the AP 1106, and the AP 1106 may detect whether each of the four sub-channels BW20[0-3] has significant interference. In FIG. 11, the AP 1106 may detect that the sub-channel BW20[3] is interfered by the WD 1108 without detecting another sub-channel BW20[2] being interfered by the WD 1102. The AP 1106 cannot detect the WD 1102 due to the physical distance between them.

Therefore, the AP 1106 may request the Wi-Fi device 1104 to monitor and report the channel conditions of the sub-channels BW20[0-3]. In an embodiment, the Wi-Fi device 1104 may employ the preamble puncturing (PP) technique to detect and report channel conditions across the selected channel by subdividing the operating bandwidth of the selected channel into discrete 20 MHz sub-channels BW20[0] to BW20[3] and continuously assessing each sub-channel BW20[i] independently for interference and signal quality. Upon detecting interference in one or more sub-channels, the Wi-Fi device 1104 may generate a disabled sub-channel bitmap indicating which sub-channels are punctured, wherein each bit position in the bitmap corresponds to a specific sub-channel BW20[i] within the operating channel. The Wi-Fi device 1104 may transmit the bitmap in a management frame to inform the AP 1106, thereby excluding the affected 20 MHz sub-channel from data transmission while maintaining operation on the remaining non-punctured sub-channels. In FIG. 11, the Wi-Fi device 1104 may detect interference on the sub-channel BW20[2] caused by the WD 1102, puncture the affected sub-channel BW20[2], and report the punctured sub-channel BW20[2] to the AP 1106. Then, the AP 1106 may remove the sub-channels [2-3] and select the sub-channels BW20[0-1] which experience little interference to form the operating channel.

The present invention introduces channel bandwidth adaptation methods and a WLAN device that dynamically responds to interference. By continuously monitoring sub-channels within a wideband channel, the device identifies and avoids interfered sub-channels. This allows uninterrupted listening and quick recovery when interference subsides, maximizing throughput. Unlike conventional approaches, the methods update the bandwidth of the operating channel, offering efficient, low-latency channel management.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A channel bandwidth adaptation method performed by a WLAN (wireless local area network) circuit for use in a WLAN device, the method comprising
monitoring N sub-channels within a selected channel to determine N channel conditions, N being a quantity of sub-channels in the selected channel, and N being an integer greater than 1;
selecting M sub-channels from the N sub-channels based on at least the N channel conditions to adapt an operating channel, M being a positive integer less than or equal to N; and
notifying a peer WLAN device of an adapted operating channel comprising the M sub-channels.

2. The method of claim 1, wherein selecting the M sub-channels from the N sub-channels based on at least the N channel conditions comprises:
removing, from the N sub-channels, any sub-channel having a channel condition indicating interference; and
selecting the M sub-channels from sub-channels remaining in the N sub-channels.

3. The method of claim 1, wherein selecting the M sub-channels from the N sub-channels based on at least the N channel conditions comprises:
identifying a known interference source;
removing, from the N sub-channels, a sub-channel on which the interference source operates; and
selecting the M sub-channels from sub-channels remaining in the N sub-channels.

4. The method of claim 3, wherein the interference source is a toll transaction terminal.

5. The method of claim 3, wherein the interference source is a vehicular communication device.

6. The method of claim 1, wherein selecting the M sub-channels from the N sub-channels based on at least the N channel conditions comprises:
receiving external channel conditions from the peer WLAN device;
removing, from the N sub-channels, each sub-channel having a channel condition indicating interference based on the external channel conditions; and
selecting the M sub-channels from sub-channels remaining in the N sub-channels.

7. The method of claim 1, wherein selecting the M sub-channels from the N sub-channels based on at least the N channel conditions comprises:
selecting the N sub-channels as the operating channel in response to the N channel conditions indicating little interference.

8. The method of claim 1, wherein notifying the peer WLAN device of the adapted operating channel comprises:
transmitting a channel switch announcement indicating a change in a primary channel of the operating channel.

9. The method of claim 1, wherein notifying the peer WLAN device of the adapted operating channel comprises:
transmitting an operating mode notification indicating a change in a secondary channel of the operating channel.

10. The method of claim 9, wherein the change in the secondary channel comprises an addition of the secondary channel.

11. The method of claim 9, wherein the change in the secondary channel comprises a deletion of the secondary channel.

12. The method of claim 1, further comprising:
after notifying the peer WLAN device of the adapted operating channel, the WLAN circuit monitoring the N sub-channels within the selected channel to update the N channel conditions.

13. A channel bandwidth adaptation method performed by a WLAN (wireless local area network) circuit for use in a WLAN device, the method comprising
operating in a selected channel comprising N sub-channels, N being a quantity of sub-channels in the selected channel, and N being an integer greater than 1;
selecting M sub-channels from the N sub-channels based on at least presence of a known interference source to adapt an operating channel, M being a positive integer less than or equal to N; and
notifying a peer WLAN device of an adapted operating channel comprising the M sub-channels.

14. The method of claim 13, wherein selecting M sub-channels from the N sub-channels based on at least the presence of the known interference source comprises:
in response to presence of the known interference source, removing, from the N sub-channels, a sub-channel on which the interference source operates; and
selecting M sub-channels from sub-channels remaining in the N channels.

15. A WLAN (wireless local area network) device comprising
a WLAN circuit configured to monitor N sub-channels within a selected channel to determine N channel conditions, wherein N is a quantity of sub-channels in the selected channel, and N is an integer greater than 1;
a processing unit; and
a memory coupled to the processing unit, configured to store instructions;
wherein the instructions, when executed by the processing unit, causes the processing unit to select M sub-channels from the N sub-channels based on at least the N channel conditions to adapt an operating channel, M being a positive integer less than or equal to N; and
the WLAN circuit is further configured to notify a peer WLAN device of an adapted operating channel comprising the M sub-channels.

16. The WLAN device of claim 15, wherein the instructions, when executed by the processing unit, causes the processing unit to:
remove, from the N sub-channels, any sub-channel having a channel condition indicating interference; and
select the M sub-channels from sub-channels remaining in the N sub-channels.

17. The WLAN device of claim 15, wherein the instructions, when executed by the processing unit, causes the processing unit to:
identify a known interference source;
remove, from the N sub-channels, a sub-channel on which the interference source operates; and
select the M sub-channels from sub-channels remaining in the N sub-channels.

18. The WLAN device of claim 15, wherein the instructions, when executed by the processing unit, causes the processing unit to:
receive external channel conditions from the peer WLAN device;
remove, from the N sub-channels, each sub-channel having a channel condition indicating interference based on the external channel conditions; and
select the M sub-channels from sub-channels remaining in the N sub-channels.

19. The WLAN device of claim 15, wherein the processing unit and the memory are located inside the WLAN circuit or coupled to the WLAN circuit.

20. The WLAN device of claim 19, wherein:
the processing unit and the memory are coupled to the WLAN circuit;
another processing unit and another memory are located inside the WLAN circuit or are coupled to the WLAN circuit, the another memory being configured to store other instructions; and
the other instructions, when executed by the another processing unit, causes the another processing unit work with the processing unit to select the M sub-channels from the N sub-channels based on at least the N channel conditions to adapt the operating channel.
